(19) United States
(12) Patent Application Publication
(10) Pub. No.: US 2025/0348364 A1
(43) Pub. Date: Nov. 13, 2025

(54) COMPUTER SYSTEM AND PARAMETER CHANGING METHOD

(71) Applicant: Hitachi, Ltd., Tokyo (JP)

(72) Inventor: Yuichi SAKURAI, Tokyo (JP)

(21) Appl. No.: 19/087,913

(22) Filed: Mar. 24, 2025

(30) Foreign Application Priority Data
May 9, 2024 (JP) 2024-076565

(51) Int. Cl. G06F 9/50

(52) U.S. Cl. CPC G06F 9/505; G06F 9/5016

(57) ABSTRACT

A computer system includes processors and memory resources, comprising: a load prediction unit that estimates load items as part of a target device's performance state using a load prediction table for a design parameter of the target device; an accuracy prediction unit that estimates reliability items as part of the performance state using an accuracy prediction table for the design parameter; a stability determination unit that determines whether the target device operates in a stable or unstable state using the design parameter and a determination model based on a performance profile indicating the performance state; and a warning unit that displays instability factors, which are load or reliability items, in descending order of their contribution to operational improvement when the operation is estimated to be in an unstable state.

### CROSS-REFERENCE TO RELATED APPLICATION

The present application claims priority from Japanese application JP2024-076565, filed on May 9, 2024, the content of which is hereby incorporated by reference into this application.

### BACKGROUND

### Technical Field

The present invention relates to a computer system and a parameter changing method.

### Related Art

A computer-controlled automated operation is spreading in industrial facilities. Among them, in processes of inspection and quality check, a performance of hardware and software for inspection has been improved, and automation has been progressing. For example, in a process of finding a flaw of a product, a technique of photographing a flow work with a camera and performing inspection on the product by using image analysis or artificial intelligence (hereinafter, AI) has been adopted, and approaches for improving production efficiency of the product are increasing.

On the other hand, in the inspection processing as described above, it is required to achieve both high-speed processing by a computer system and enhancement of a determination reliability of flaw detection processing by the AI, and load prediction of hardware resources of the computer system and determination reliability prediction of the AI become important techniques for stable operation.

JP 2017-041185 A describes a technique for providing a management server device and a management program capable of flexibly coping with load fluctuations of a processing node in a state where a processing load associated with addition or deletion of the processing node to or from a processing node cluster is made constant.
Patent document 1 JP 2017-041185 A

### SUMMARY

However, the technique described in JP 2017-041185 A does not cope with change of design parameters essential for speeding up the computer system, simulation of an influence (operational stability/instability) thereof in advance, and change of control parameters in order to prevent instability. An object of the present invention is to provide a technique for preventing operational instability caused by a design parameter change.

The present application includes a plurality of means for solving at least a part of the above problems, and examples thereof are as follows. A computer system according to one aspect of the present invention that solves the above problem is a computer system including one or more processors and one or more memory resources, in which the one or more processors each include a load prediction unit which estimates one or more load items to be a part of a performance state of a target device with a changed design, by using a predetermined load prediction table for a design parameter of the target device, an accuracy prediction unit which estimates one or more reliability items to be a part of the performance state, by using a predetermined accuracy prediction table for the design parameter, a stability determination unit which estimates whether an operation of the target device is in a stable state or an unstable state, by using the design parameter and a determination model which determines whether the target device is in a stable state or an unstable state by using a performance profile indicating the performance state as an input, and a warning unit which displays, as instability factors, the load items or the reliability items in descending order of a contribution degree contributing to improvement of the operation in a case where the operation is estimated to be in the unstable state.

According to the present invention, it is possible to provide a technique for preventing operational instability caused by a design parameter change. Problems, configurations, and effects other than those described above will be clarified by the following description of embodiments for carrying out the invention.

### BRIEF DESCRIPTION OF DRAWINGS

FIG. 1 is a diagram illustrating a configuration example of an influence prediction system;

FIG. 2 is a diagram illustrating an example of a hardware configuration of an influence prediction device;

FIG. 3 is a diagram illustrating an example of a data structure of design parameter data;

FIG. 4 is a diagram illustrating an example of a data structure of performance profile data;

FIG. 5 is a diagram illustrating an example of a data structure of a determination model;

FIG. 6 is a diagram illustrating an example of a data structure of a load prediction table;

FIG. 7 is a diagram illustrating an example of a data structure of an accuracy prediction table;

FIG. 8 is a diagram illustrating an example of a processing flow of performance test necessity determination processing;

FIG. 9 is a diagram illustrating an example of a performance prediction result screen;

FIG. 10 is a diagram illustrating a second configuration example of the influence prediction system;

FIG. 11 is a diagram illustrating an example of a data structure of dynamic performance profile data;

FIG. 12 is a diagram illustrating an example of a processing flow of the performance test necessity determination processing (dynamic use);

FIG. 13 is a diagram illustrating a configuration example of an influence control system;

FIG. 14 is a diagram illustrating an example of a data structure of an instability factor correspondence table;

FIG. 15 is a diagram illustrating an example of a processing flow of stabilization processing;

FIG. 16 is a diagram illustrating a configuration example of a modification of the influence control system;

FIG. 17 is a diagram illustrating an example of the instability factor correspondence table;

FIG. 18 is a diagram illustrating a third configuration example of the influence prediction system; and

FIG. 19 is a diagram illustrating an example of a data structure of a load prediction model.

### DETAILED DESCRIPTION

### First Embodiment

Hereinafter, embodiments of the present invention will be described with reference to the drawings. The embodiments are examples for describing the present invention, and are omitted and simplified as appropriate for clarity of description. The present invention can be implemented in various other forms. Unless otherwise specified, each component may be singular or plural.

Positions, sizes, shapes, ranges, and the like of the components illustrated in the drawings may not represent actual positions, sizes, shapes, ranges, and the like in order to facilitate understanding of the invention. Therefore, the present invention is not necessarily limited to the position, size, shape, range, and the like disclosed in the drawings.

For example, various types of information may be described in terms of expressions such as “table”, “list”, and “queue”, but the various types of information may be expressed in a data structure other than these. For example, various types of information such as “XX table”, “XX list”, and “XX queue” may be “XX information”. In describing identification information, expressions such as “identification information”, “identifier”, “name”, “ID”, and “number” are used, but these can be replaced with each other. In addition, the identification information described in these expressions is represented by using symbols, numerical values, natural languages, combinations thereof, or the like in the embodiments, but the identification information may be in a format other than these.

In a case where there is a plurality of components having the same or similar functions, the same reference numerals may be attached with different subscripts for description. In addition, in a case where it is not necessary to distinguish the plurality of components, the description may be made by omitting the subscripts.

In the embodiment, processing performed by executing a program may be described. Here, a computing device executes a program by a processor (for example, a CPU, a GPU, or a quantum processor), and performs processing defined by the program by using a storage resource (for example, a memory), an interface device (for example, a communication port), and the like. Therefore, a subject of the processing performed by executing the program may be a processor. Similarly, the subject of the processing performed by executing the program may be a controller, a device, a system, a computing device, or a node having the processor. The subject of the processing performed by executing the program is only required to be an arithmetic unit, and may include a dedicated circuit that performs specific processing. Here, the dedicated circuit is, for example, a field programmable gate array (FPGA), an application specific integrated circuit (ASIC), a complex programmable logic device (CPLD), or the like.

The program may be installed on the computing device from a program source. The program source may be, for example, a program distribution server or a computing device-readable storage medium. In a case where the program source is the program distribution server, the program distribution server may include a processor and a storage resource that stores a distribution target program, and the processor of the program distribution server may distribute the distribution target program to another computing device. In addition, in the embodiment, two or more programs may be realized as one program, or one program may be realized as two or more programs.

In addition, the present invention is typically implemented by an information processing device, but may be implemented as a platform having the functions of the present invention.

An influence prediction system 1 is used during operation or maintenance of a computer system or in preparation work for reusing and redistributing the computer system. Since such a computer system is typically configured by an electronic device, the electronic device is mainly exemplified in the present embodiment.

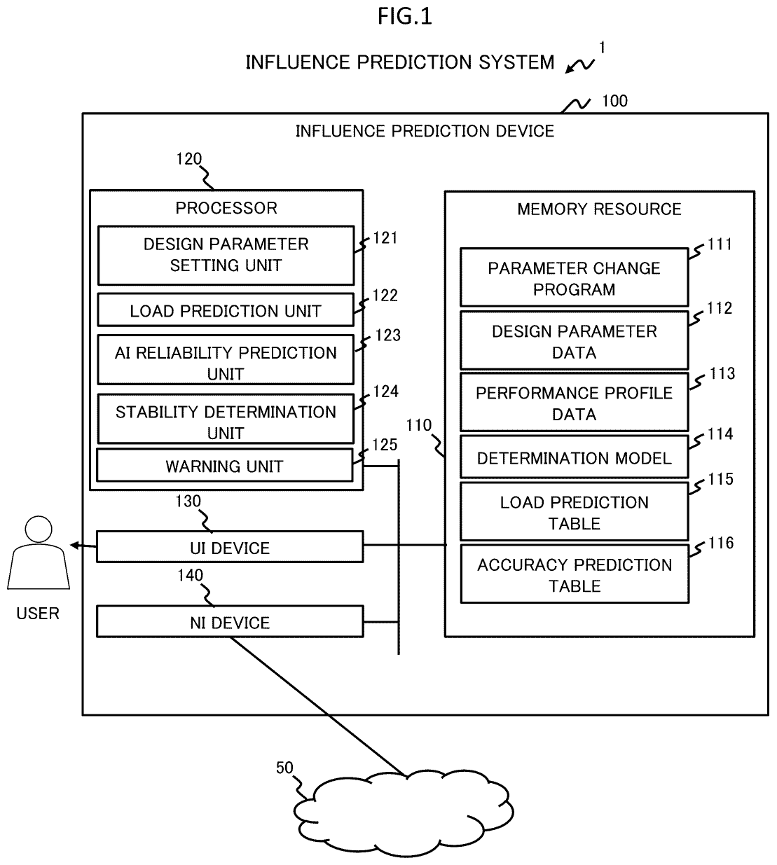

FIG. 1 is a diagram illustrating a configuration example of the influence prediction system. The influence prediction system 1 includes an influence prediction device 100. Furthermore, a plurality of computer systems to be predicted (hereinafter, may be simply referred to as “target devices”) by the influence prediction system 1 are, for example, a product inspection device or the like, and exist via a network 50.

For example, the influence prediction device 100 is an information processing device including a memory resource 110, a processor 120, a user interface (UI) device 130, and a network interface (NI) device 140.

The memory resource 110 includes a parameter change program 111, design parameter data 112, performance profile data 113, a determination model 114, a load prediction table 115, and an accuracy prediction table 116.

The parameter change program 111 is a software program that causes the processor 120 to execute performance test necessity determination processing to be described later. For example, the parameter change program 111 may be a binary object described in C language or the like and compiled, or may be a script file written in Python language.

The design parameter data 112 is a control parameter of a hardware resource designed for the target device, for example, the target device such as the product inspection device, or specification data of implemented hardware. The design parameter data 112 is information regarding the design of the target device, and is a set of existing information such as model information created by model-based system engineering (MBSE) and computer aided design (CAD) information.

The performance profile data 113 is performance profile data indicating a performance state of the target device, for example, the target device such as the product inspection device. The performance profile data 113 includes one or more load items to be a part of the performance state and one or more reliability items to be a part of the performance state. Note that the load items include an item indicating a use state of hardware resources of the target device, for example, one or more of items such as an output frames per seconds (fps) of a camera connected to the target device, a central processing unit (CPU) load, a graphics processing unit (GPU) load, an internal queue, and a temperature. The reliability items include AI determination reliability (prediction accuracy of AI) which is accuracy information representing, in a distributed manner, a certainty of an estimation result of AI used in the target device.

The determination model 114 is a model obtained by multivariate analysis, in which each pair of a design parameter and its corresponding performance profile is associated. Specifically, the determination model 114 is a model in which the design parameter and the performance profile of the target device, for example, the target device such as the product inspection device are used as explanatory variables, and an operating state of the target device, for example, the target device such as the product inspection device is used as an objective variable. Therefore, the determination model 114 can determine whether the target device is in a stable state or an unstable state, by using the design parameter and the performance profile indicating the performance state as inputs.

The load prediction table 115 includes a load prediction constant based on an actual value of a performance profile for a past design parameter.

The accuracy prediction table 116 includes an accuracy prediction constant based on the actual value of the performance profile for the past design parameter.

The processor 120 performs the performance test necessity determination processing (described later) by the parameter change program 111. Specifically, the processor 120 includes a design parameter setting unit 121, a load prediction unit 122, an AI reliability prediction unit 123, a stability determination unit 124, and a warning unit 125.

The design parameter setting unit 121 reads the design parameter data 112 of the target device and sets the design parameter data 112 as the design parameter.

By using the load prediction table 115 for the design parameter of the target device with a changed design, the load prediction unit 122 estimates one or more load items to be a part of the performance state of the target device, by using the load prediction constant.

By using the accuracy prediction table 116 for the design parameter, the AI reliability prediction unit 123 estimates one or more reliability items to be a part of the performance state, by using the accuracy prediction constant. The AI reliability prediction unit 123 may also be referred to as an accuracy prediction unit.

The stability determination unit 124 estimates whether the operation of the target device is in the stable state or the unstable state, by using the determination model which determines whether the target device is in the stable state or the unstable state by using the design parameter data 112 and the performance profile data 113 indicating the performance state as inputs.

In a case where the operation of the target device is estimated to be in the unstable state, the warning unit 125 displays, as instability factors, the load items or the reliability items in descending order of a contribution degree contributing to the improvement of the operation. Note that the contribution degree will be described later.

The UI device 130 receives inputs of various instructions from a user (operator). The input content includes at least information regarding the design parameter data 112 of the target device. For example, the UI device 130 receives designation of a value of the design parameter data 112 via an input device such as a mouse or a keyboard. Note that the UI device 130 receives an input of information regarding influence prediction without being limited to the design parameter data 112 of the target device. For example, the UI device 130 receives inputs of the load prediction table 115, the accuracy prediction table 116, and the like.

The UI device 130 displays at least a factor causing unstable operation of the target device on a screen via a display device. Therefore, the UI device 130 may be configured integrally with the input device such as a touch panel. Furthermore, the UI device 130 may be configured as a housing separate from the influence prediction device 100. In this case, the UI device 130 may be realized by another terminal device, and input information and output information may be transferred via a network.

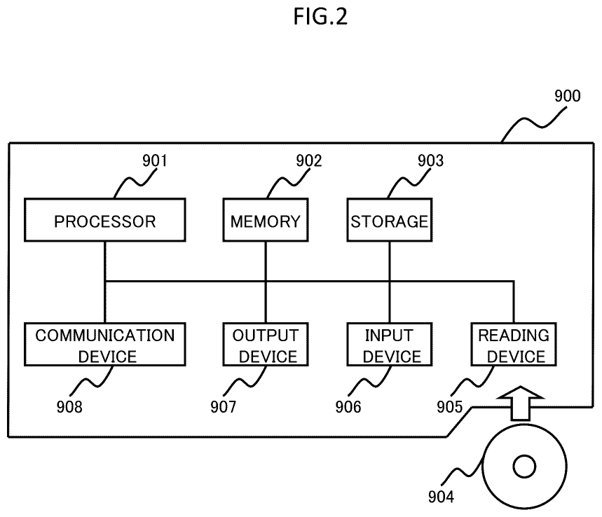

The NI device 140 is connected to an external device for mutual communication via a communication path such as the network 50 which is any one of or a combination of a communication network using all or some of a public network such as the Internet, a local area network (LAN), a wide area network (WAN), a virtual private network (VPN), and the like, a mobile phone communication network, and the like. Incidentally, the network 50 may be a wireless communication network such as Wi-Fi (registered trademark) or 5G (Generation).

[Description of Hardware Configuration] FIG. 2 is a diagram illustrating an example of a hardware configuration of the influence prediction device. The influence prediction device 100 can be realized by a general information processing device 900 including a processor 901, a memory 902 of hardware such as a random access memory (RAM), a storage 903 such as a hard disk drive (HDD) or a solid state drive (SSD), a reading device 905 that reads information with respect to a portable storage medium 904 such as a compact disk (CD) or a digital versatile disk (DVD), an input device 906 such as a keyboard, a mouse, a bar code reader, or a touch panel, an output device 907 such as a display, and a communication device 908 that communicates with another computer via a communication network such as a LAN or the Internet, or a network system including a plurality of the information processing devices 900. Note that the reading device 905 may be capable of not only reading the portable storage medium 904 but also writing.

The processor 901 is, for example, a CPU or a GPU. The processor 901 executes various types of processing by executing predetermined various programs loaded from the storage 903 to the memory 902. The program is, for example, an application program that can be executed on an operating system (OS) program. For example, the program may be installed in the storage 903 from the portable storage medium 904 via the reading device 905, or may be downloaded from a network via the communication device 908 and executed by the processor 901.

For example, the design parameter setting unit 121, the load prediction unit 122, the AI reliability prediction unit 123, the stability determination unit 124, and the warning unit 125 can be realized by loading a program stored in the storage 903 into the memory 902 and executing the program by the processor 901.

Note that the storage 903 may include a nonvolatile memory such as a magnetoresistive RAM (MRAM), a phase change RAM (PRAM), or a resistive RAM (ReRAM).

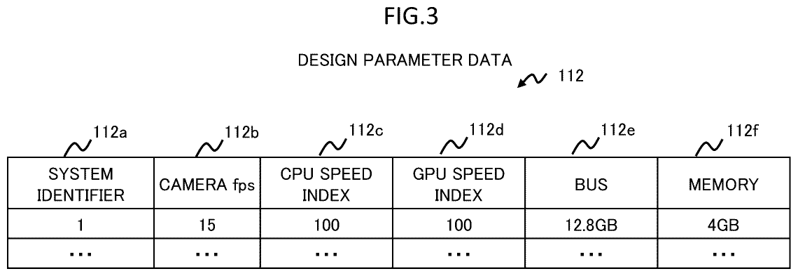

The UI device 130 can be realized by the processor 901 using the input device 906, the output device 907, and the communication device 908. The memory resource 110 can be realized by the processor 901 using the memory 902 or the storage 903. The NI device 140 can be implemented by the processor 901 using the communication device 908.

[Description of Data] FIG. 3 is a diagram illustrating an example of a data structure of design parameter data. The design parameter data 112 includes, for each system identifier 112a of a system to which the target device belongs, a camera fps 112b, a CPU speed index 112c, a GPU speed index 112d, a bus 112e that is a capacity of a bus, and a memory 112f that is a capacity of a memory, in association with one another.

The camera fps 112b is the input fps of the camera connected to the target device. The CPU speed index 112c is a value obtained by normalizing a certain reference value to 100. The GPU speed index 112d is a value obtained by normalizing a certain reference value to 100.

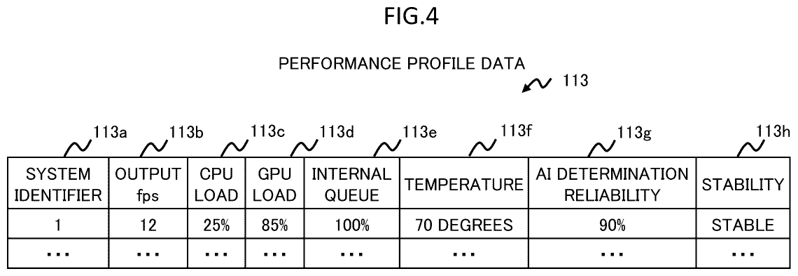

FIG. 4 is a diagram illustrating an example of a data structure of performance profile data. The performance profile data 113 includes, for each system identifier 113a of the system to which the target device belongs, an output fps 113b, a CPU load 113c, a GPU load 113d, an internal queue 113e, a temperature 113f, an AI determination reliability 113g, and a stability 113h, in association with one another.

The output fps 113b is an output frequency of the AI calculation module of the target device when the target device is operated with the design parameter data 112. The CPU load 113c is a load factor of the CPU. The GPU load 113d is a load factor of the GPU. The internal queue 113e is a usage rate of a queue inside software. The temperature 113f is the temperature of the target device. The AI determination reliability 113g is reliability with respect to a determination result of deep learning. The stability 113h is information regarding a determination result of stability and instability of the target device.

The stability 113h stores subjective determination results from a designer of the target device and a person in charge of performance test. For example, in the determination result, the designer or the person in charge of performance test determines that the target device is unstable in a case where the use of the target device becomes difficult, such as a case where the CPU load factor or the GPU load factor exceeds an initial assumed utilization factor as a result of a short-term performance test, a case where the operation or reaction of the target device is delayed in a long-term performance test, a case where a calculation accuracy of AI is deteriorated, a case where an operation of the OS is stopped, or a case where the target device generates heat more than the initial assumed heat. Otherwise, the designer or the person in charge of performance test determines that the target device is stable.

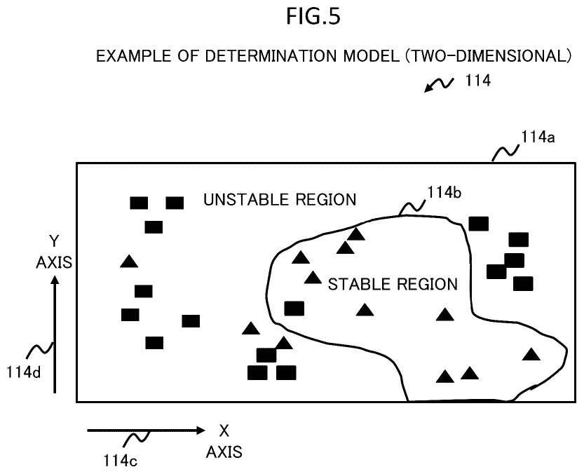

FIG. 5 is a diagram illustrating an example of a data structure of the determination model. The determination model 114 is a model obtained by multivariate analysis processing such as Support-Vector-Machine (SVM) with the design parameter data 112 and the performance profile data 113 as inputs. In the example of FIG. 5, an example is illustrated in which a kernel 114a of the SVM in a case where the input item is two-dimensional (X axis 114c, Y axis 114d) is visualized for easy visualization. Each point plotted in the drawing corresponds to the target device, and a non-linear boundary is drawn between a stable region 114b included in a case where the operation of the target device is stable and a region in a case where the operation becomes unstable. That is, in the example of FIG. 5, by specifying and plotting a value in an X-axis 114c direction and a value in a Y-axis 114d direction for each target device, it can be inferred that if the values are included in the stable region 114b, the operation is stable, and otherwise, the operation is unstable.

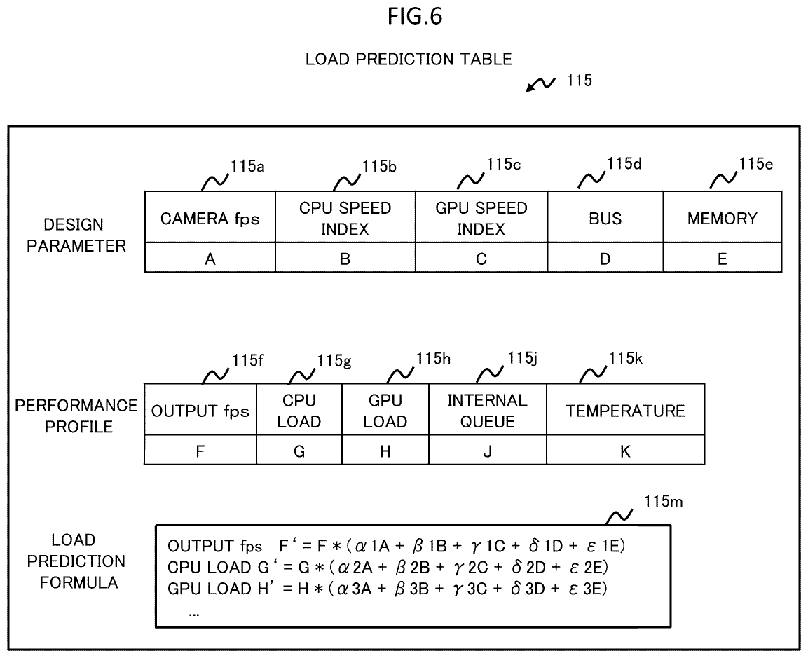

FIG. 6 is a diagram illustrating an example of a data structure of the load prediction table. The load prediction table 115 includes design parameters, a performance profile, and a load prediction formula. The design parameters include some or all of the design parameter data 112, and the performance profile includes some or all of the performance profile data 113. The load prediction formula is a formula for predicting a load by correcting the performance profile according to the design parameters.

In the example of FIG. 6, the design parameters include a camera fps 115a, a CPU speed index 115b, a GPU speed index 115c, a bus 115d, and a memory 115e. The performance profile includes an output fps 115f, a CPU load 115g, a GPU load 115h, an internal queue 115j, and a temperature 115k. Then, a load prediction formula 115m includes a formula for obtaining a prediction value of the performance profile.

For example, as a formula for calculating F′ which is the output fps, the load prediction formula 115m includes multiplying values of parameters A, B, C, D, and E of the design parameters by load prediction constants α1, β1, γ1, δ1, and ε1 (performing weighting), respectively, and multiplying the obtained values by F which is the value of the output fps of the performance profile. Note that the load prediction formula 115m is expressed by an easy linear formula for simplification of description, but is not limited to the form of this formula, and another prediction formula can also be used.

Furthermore, for example, in order to improve an imaging system performance of the target device, it is assumed that the camera fps 115a is changed from “15” to “30” in the design parameter data 112. In addition, it is assumed that a load prediction constant α1 of the formula for obtaining the output fps F′ of the load prediction formula of the load prediction table 115 is “1/15”, a load prediction constant α2 of the formula for obtaining a CPU load G′ is “1/15”, and a load prediction constant α3 of the formula for obtaining a GPU load H′ is “1/15”. In general, when the camera fps 115a of the design parameter increases, the image information used for input increases, and thus, each of the output fps, the CPU load, and the GPU load similarly increases. As a result, under the load prediction formula 115m, the output fps may be calculated as “24”, the CPU load as “50%”, and the GPU load as “100%”. Note that the present invention is not limited thereto, and when the load prediction formula is different, the prediction performance profile is naturally different.

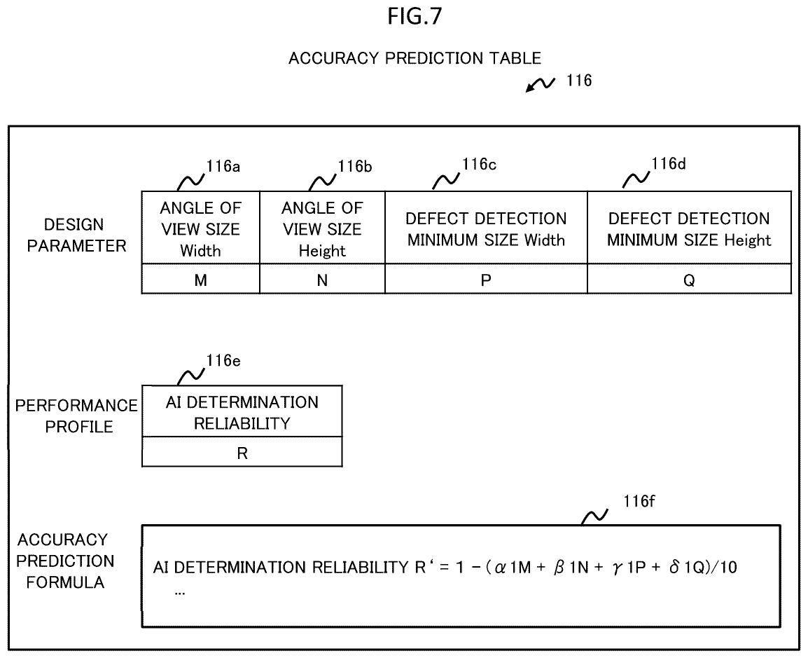

FIG. 7 is a diagram illustrating an example of a data structure of the accuracy prediction table. The accuracy prediction table 116 includes design parameters, a performance profile, and an accuracy prediction formula. The design parameters include some or all of the design parameter data 112, and the performance profile includes some or all of the performance profile data 113. The accuracy prediction formula is a formula for predicting an accuracy by correcting the performance profile according to the design parameters.

In the example of FIG. 7, the design parameters include an angle of view size Width 116a, an angle of view size Height 116b, a defect detection minimum size Width 116c, and a defect detection minimum size Height 116d. The performance profile includes an AI determination reliability 116e. Then, an accuracy prediction formula 116f includes a formula for obtaining a prediction value of the performance profile. Note that, in a system in which an image captured by a camera is analyzed to detect a flaw of a product, it is known that surrounding illumination when imaging the product significantly affects a detection accuracy. Therefore, the illuminance may be added to the design parameters.

For example, as a formula for calculating an AI determination reliability R′, the accuracy prediction formula 116f includes multiplying values of parameters M, N, P, and Q of the design parameters by the load prediction constants α1, β1, γ1, and δ1 (performing weighting), respectively, and subtracting the obtained values from the entire “1”. Note that the accuracy prediction formula 116f is expressed by an easy linear formula for simplification of description, but is not limited to the form of this formula, and another prediction formula can also be used.

The angle of view size Width 116a is information for specifying a width in an imaging range of the camera. The angle of view size Height 116b is information for specifying a height in the imaging range of the camera. A defect detection minimum size Width 116c is information for specifying a minimum width among sizes on the screen of defects such as a flaw to be detected. A defect detection minimum size Height 116d is information for specifying a minimum height among sizes on the screen of the defects such as the flaw to be detected. Since a flaw less than the defect detection minimum size is excluded from a detection target, the defect detection minimum size is set to be large so as not to perform a small flaw, so that it is possible to reduce processing load and the time required for processing although the accuracy is lowered. In addition, the AI determination reliability is statistical calculation of a reliability in a determination result in a deep learning model solving a classification problem, and is a value output by the deep learning model itself.

In addition, other than the above example in which the reliability in the determination result of deep learning is used for the performance profile, prediction of a determination accuracy of statistical machine learning such as the deep learning includes a method of evaluating with a data set created in advance, a method of collecting and determining together the presence or absence of determination that conflicts with safety in the case of control related to safety (for example, in an arm robot, collecting movements, which are faster or larger than a predetermined threshold, in addition to picking accuracy and speed), a method of monitoring statistical measures of input data to detect a change point, and the like. These may be included in the accuracy prediction table 116 to predict the accuracy.

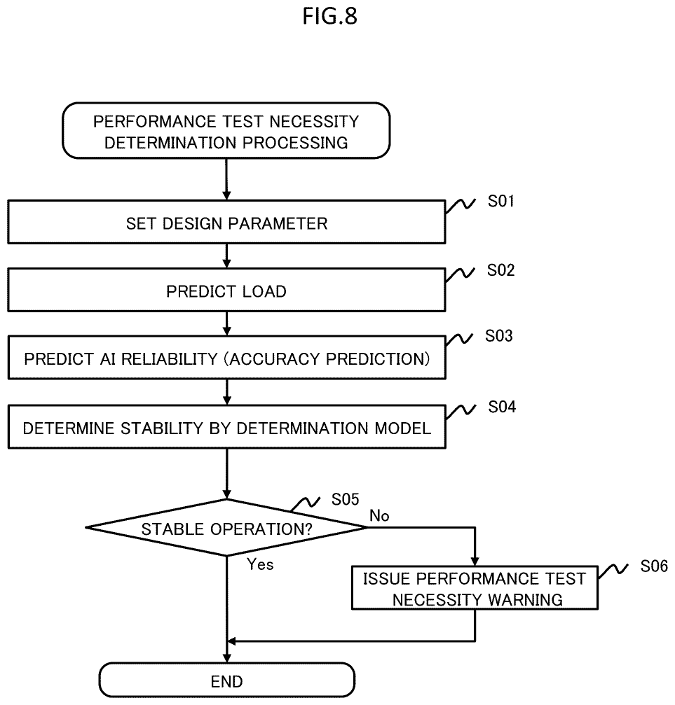

As an example of the accuracy prediction using the accuracy prediction table 116, it is assumed that the angle of view size Width 116a is changed from “1024” to “2048” in the design parameter data 112 in order to improve the imaging system performance of the target device. In addition, it is assumed that the accuracy prediction constant α1 of the formula for obtaining the AI determination reliability R′ of the accuracy prediction formula of the accuracy prediction table 116 is “1/1024”. In general, when the angle of view size Width 116a of the design parameter increases, a range of the detection target increases, and thus, the AI determination reliability R′ decreases. As a result, the AI determination reliability can be calculated as “80%” under the accuracy prediction formula 116f. Note that the present invention is not limited thereto, and when the accuracy prediction formula is different, the prediction performance profile is naturally different.

[Description of Operation] FIG. 8 is a diagram illustrating an example of a processing flow of the performance test necessity determination processing. The performance test necessity determination processing is started, for example, when the UI device 130 receives an execution instruction of the performance test necessity determination processing from the user.

First, the design parameter setting unit 121 sets design parameters (step S01). Specifically, the design parameter setting unit 121 reads the design parameter data 112 and receives the design parameter data via the UI device 130 when there is correction.

Then, the load prediction unit 122 performs load prediction (step S02). Specifically, the load prediction unit 122 estimates one or more load items (load items in the performance profile) to be a part of the performance state of the target device, by using the load prediction table 115 for the design parameter of the target device with a changed design. More specifically, the load prediction unit 122 estimates each value of the load item by performing calculation by applying the value of the design parameter to the load prediction formula 115m including the load prediction constant.

Then, the AI reliability prediction unit 123 performs AI reliability prediction (step S03). Specifically, the AI reliability prediction unit 123 estimates one or more reliability items (reliability items in the performance profile) to be a part of the performance state, by using the accuracy prediction table 116 for the design parameter. Specifically, the AI reliability prediction unit 123 estimates each value of the reliability item by performing calculation by applying the value of the design parameter to the accuracy prediction formula 116f including the accuracy prediction constant. Note that, in general, it is obvious from experience that the load is generally proportional to a computation amount, but it tends to be difficult to specify dominant items regarding the AI determination reliability.

Then, the stability determination unit 124 determines the stability by the determination model (step S04). Specifically, the stability determination unit 124 estimates whether the operation of the target device is in the stable state or the unstable state, by applying the design parameter data 112 and the performance profile data 113 indicating the performance state to the determination model 114 which determines whether the target device is in the stable state or the unstable state.

Then, the stability determination unit 124 determines whether or not the determination result of the stability by the determination model is “stable” (step S05). If the operation is estimated to be in the stable state (“Yes” in step S05), the stability determination unit 124 outputs a performance prediction result screen to be described later, and ends the performance test necessity determination processing.

If the operation is not estimated to be in the stable state (“No” in step S05), the warning unit 125 issues a performance test necessity warning (step S06). Specifically, the warning unit 125 outputs the performance test necessity warning included in the performance prediction result screen to be described later, and ends the performance test necessity determination processing.

In a case where the operation of the target device is estimated to be in the unstable state, the warning unit 125 displays, as the instability factors, the load items or the reliability items in descending order of the contribution degree contributing to the improvement of the operation. Note that the warning unit 125 specifies a vector distance from the plotted position to the closest stable region on the determination model 114, and calculates, as the contribution degree, the distance of each of the item components of the design parameter or the performance profile.

The above is an example of the processing flow of the performance test necessity determination processing. According to the performance test necessity determination processing, in a case where it is estimated that the operation of the target device becomes unstable when the design parameter is changed, the warning can be obtained to perform the performance test. Therefore, in a case where it is estimated that the operation of the target device is stable, the performance test can be omitted, so that it is possible to efficiently prevent the operational instability due to the design parameter change.

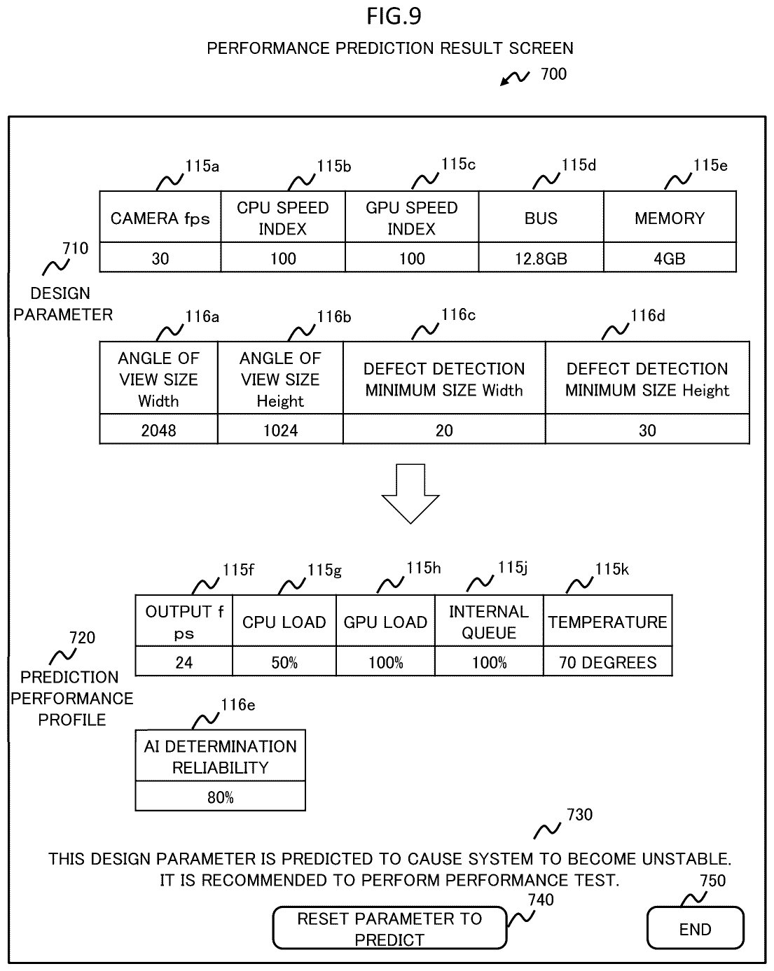

FIG. 9 is a diagram illustrating an example of the performance prediction result screen. An example 700 of the performance prediction result screen includes a design parameter display region 710, a prediction performance profile display region 720, a performance test necessity warning display region 730, a re-execution instruction reception button 740, and an end instruction reception button 750.

The design parameter display region 710 includes the camera fps 115a, the CPU speed index 115b, the GPU speed index 115c, the bus 115d, the memory 115e, the angle of view size Width 116a, the angle of view size Height 116b, the defect detection minimum size Width 116c, and the defect detection minimum size Height 116d.

The prediction performance profile display region 720 includes the output fps 115f, the CPU load 115g, the GPU load 115h, the internal queue 115j, the temperature 115k, and the AI determination reliability 116e.

In the performance test necessity warning display region 730, a message referring to the fact that the operation is estimated to be unstable and the necessity of the performance test is displayed. For example, the performance test necessity warning display region 730 displays a message such as “This design parameter is predicted to cause the system to become unstable. It is recommended to perform a performance test.”

When receiving an input, the re-execution instruction reception button 740 causes the screen to transition to a screen for receiving correction of the design parameter data 112. After the transition, the prediction of the performance profile can be performed again by using the modified design parameter data 112.

When receiving an input, the end instruction reception button 750 ends the performance test necessity determination processing and closes the example 700 of the performance prediction result screen.

The above is an example of the influence prediction system 1 according to the first embodiment of the present invention. According to the influence prediction system 1 according to the first embodiment, it is possible to efficiently prevent the operational instability due to the design parameter change.

Note that the present invention is not limited to the above-described embodiment, and includes various modifications. For example, the above-described embodiment has been described in detail for easy understanding of the present invention, and are not necessarily limited to those having all the described configurations. A part of the configuration of the embodiment can be replaced with another configuration, and the configuration of another embodiment can be added to the configuration of the embodiment. In addition, a part of the configuration of the embodiment can be deleted.

For example, in the above embodiment, the influence prediction device 100 predicts the performance profile data 113 to be estimated, and determines the stability on the basis of the prediction performance profile data. However, the present invention is not limited thereto, and the necessity of the performance test based on the performance profile data during the operation of the target device may be presented to the user in a timely manner. In this way, for the target device that deteriorates with time, it becomes possible to indicate the necessity of the performance test according to the performance of the performance profile data. Such a modification will be described below as a second embodiment.

### Second Embodiment

An influence prediction system 1′ according to the second embodiment is basically similar to the influence prediction system 1 according to the first embodiment. Therefore, differences will be mainly described below.

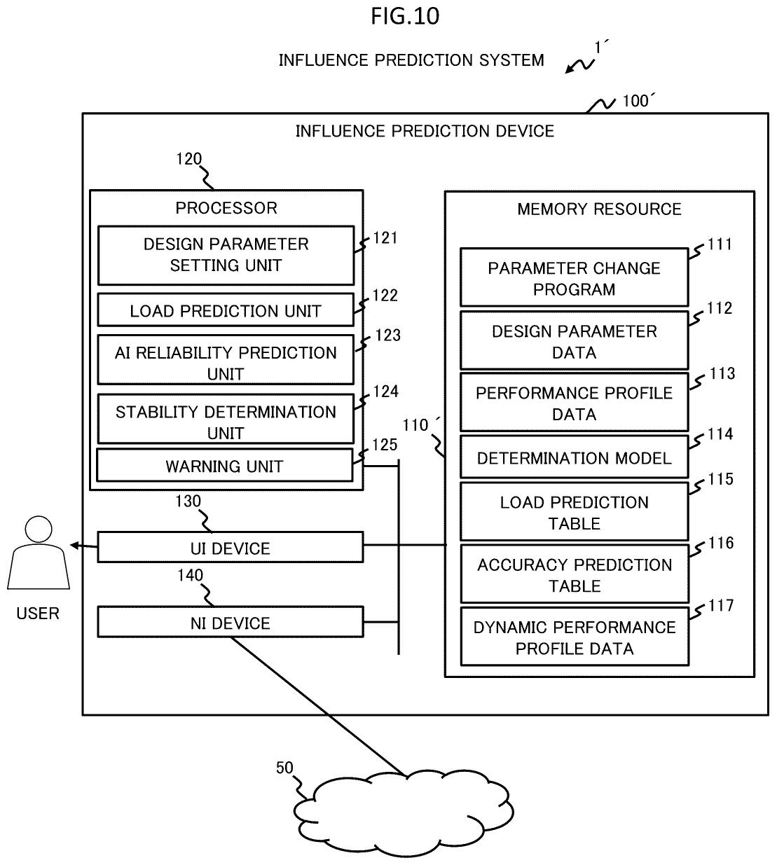

FIG. 10 is a diagram illustrating a second configuration example of the influence prediction system. In a second configuration example 1′ of the influence prediction system, an influence prediction device 100′ stores the dynamic performance profile data 117 in a memory resource 110′.

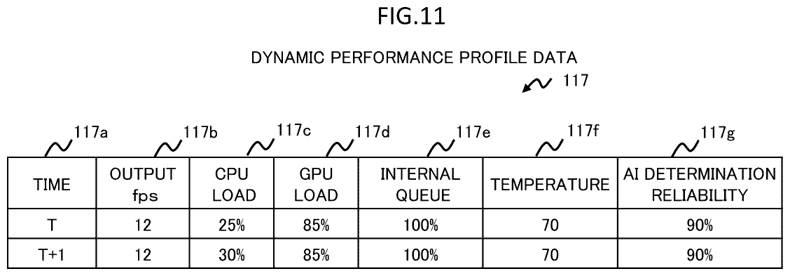

FIG. 11 is a diagram illustrating an example of a data structure of dynamic performance profile data. The dynamic performance profile data 117 records the performance profile data of the target device acquired along a time series at discrete intervals. The dynamic performance profile data 117 includes, for each time 117a, an output fps 117b, a CPU load 117c, a GPU load 117d, an internal queue 117e, a temperature 117f, and an AI determination reliability 117g, in association with one another.

The output fps 117b is an output frequency of the AI calculation module of the target device when the target device is operated with the design parameter data 112. The CPU load 117c is a load factor of the CPU. The GPU load 117d is a load factor of the GPU. The internal queue 117e is a usage rate of a queue inside software. The temperature 117f is the temperature of the target device. The AI determination reliability 117g is reliability with respect to a determination result of deep learning.

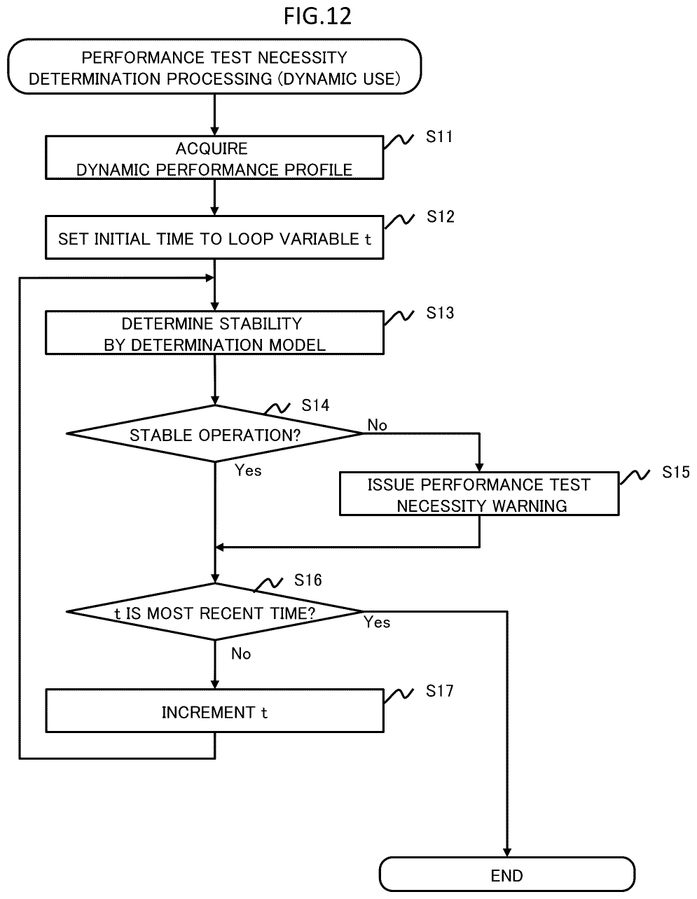

FIG. 12 is a diagram illustrating an example of a processing flow of the performance test necessity determination processing (dynamic use). The performance test necessity determination processing (dynamic use) is started, for example, when the UI device 130 receives an execution instruction of the performance test necessity determination processing (dynamic use) from the user.

First, the load prediction unit 122 acquires a dynamic performance profile (step S11). Specifically, the load prediction unit 122 reads the dynamic performance profile data 117.

Then, the load prediction unit 122 sets an initial time to a loop variable t (step S12). Specifically, the load prediction unit 122 sets, as the loop variable t, the oldest time among the times 117a of the data recorded in the dynamic performance profile data 117.

Then, the stability determination unit 124 determines the stability by the determination model (step S13). Specifically, the stability determination unit 124 estimate whether the operation of the target device is in the stable state or the unstable state at a time T, by applying the design parameter data 112 and the data at the time T (used as the loop variable t) of the dynamic performance profile data 117 indicating the performance state to the determination model 114 which determines whether the target device is in the stable state or the unstable state.

Then, the stability determination unit 124 determines whether or not the determination result of the stability by the determination model is “stable” (step S14).

If the operation is not estimated to be in the stable state (“No” in step S14), the warning unit 125 issues the performance test necessity warning (step S15). Specifically, the warning unit 125 outputs an operation log, an error log, or the like including a performance test necessity warning. Then, the stability determination unit 124 advances the control to step S16 described later.

If the operation is estimated to be in the stable state (“Yes” in step S14), the stability determination unit 124 determines whether the loop variable t is the most recent time (step S16). Specifically, the stability determination unit 124 determines whether the loop variable t is the most recent time 117a among the times 117a of the dynamic performance profile data 117. If the loop variable t is the most recent time (“Yes” in step S16), the stability determination unit 124 ends the performance test necessity determination processing.

If the loop variable t is not the most recent time (in a case of “No” in step S16), the stability determination unit 124 increments the loop variable t (for example, resets the loop variable t at the time that is the second oldest time after the loop variable t among the times 117a of the dynamic performance profile data 117) and returns the control to step S13 (step S17).

The above is an example of the processing flow of the performance test necessity determination processing (dynamic use). According to the performance test necessity determination processing (dynamic use), the necessity of the performance test based on the performance profile data during the operation of the target device can be presented to the user in a timely manner under the predetermined design parameter. Therefore, in a case where the operation of the target device is becoming unstable due to deterioration over time or the like, it is possible to indicate the necessity of the performance test as needed. The above is an example of the influence prediction system 1′ according to the second embodiment of the present invention.

In addition, in the first embodiment described above, the influence prediction device 100 issues a warning regarding the necessity of the performance test in a case where the stable operation cannot be obtained, but the invention is not limited thereto. For example, in a case where the stability of the operation is not improved even if the warning is issued, a predetermined countermeasure for stabilizing the operation of the target device may be performed. In this way, it is possible to automatically prevent an accident of the target device. Such a modification will be described below as a third embodiment.

### Third Embodiment

An influence control system 2 according to the third embodiment is basically similar to the influence prediction system 1 according to the first embodiment. Therefore, differences will be mainly described below.

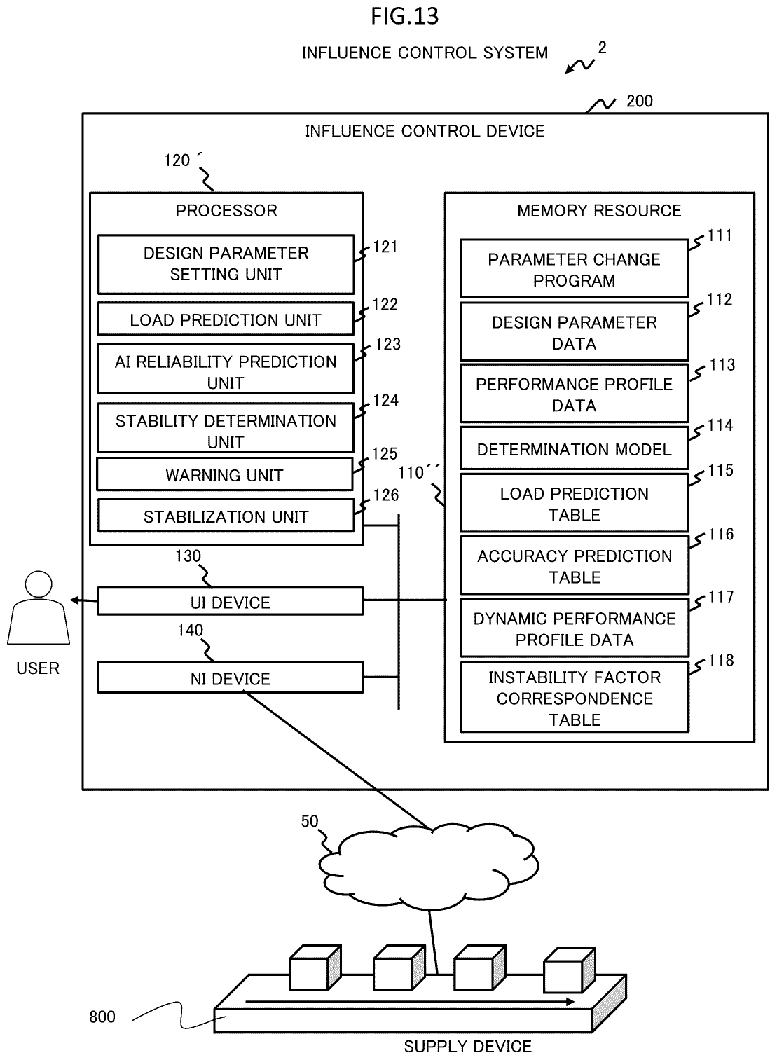

FIG. 13 is a diagram illustrating a configuration example of the influence control system. In the influence control system 2, an influence control device 200 automatically resets the control parameter of the target device (for example, a supply device 800 such as a conveyor) to be controlled, on the basis of the performance profile data during the operation of the target device. For example, the influence control device 200 performs issuing an alert, reducing the speed of the conveyor, stopping the conveyor, or the like by resetting the control parameter.

The influence control device 200 stores an instability factor correspondence table 118 in a memory resource 110″ together with the dynamic performance profile data 117. In addition, a processor 120′ includes a stabilization unit 126. The stabilization unit 126 specifies a countermeasure corresponding to the instability factor by using the instability factor correspondence table 118 and performs the countermeasure.

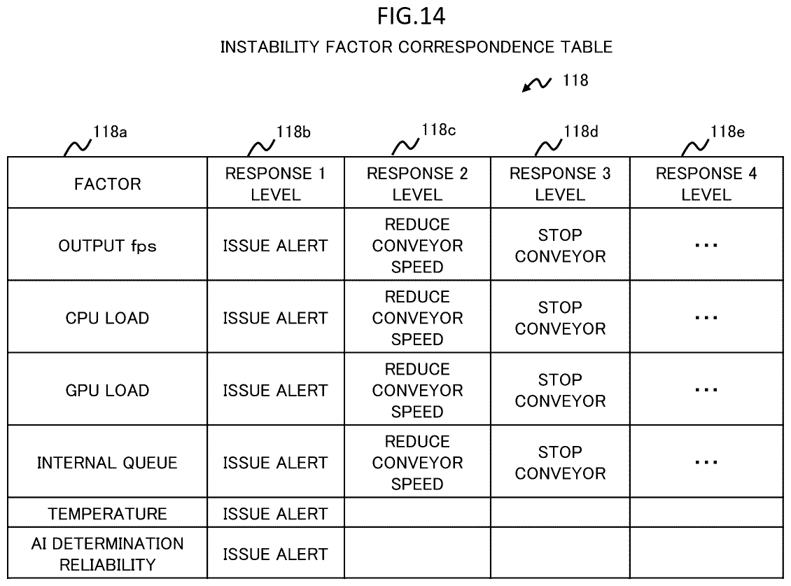

FIG. 14 is a diagram illustrating an example of a data structure of the instability factor correspondence table. In the instability factor correspondence table 118, a countermeasure for stabilizing the operation of the target device is associated according to a factor that causes the operation of the target device to be unstable. In addition, escalation can be set in order to take countermeasures in stages according to the installation environment of the target device, and a setting can be made such that, in a case where a plurality of factors have caused the operational instability, a more effective countermeasure is implemented.

Specifically, the instability factor correspondence table 118 includes, for each factor 118a, a response 1 level 118b which is a countermeasure to be implemented at a first time of the escalation, a response 2 level 118c which is a countermeasure to be implemented at a second time of the escalation, a response 3 level 118d which is a countermeasure to be implemented at a third time of the escalation, and a response 4 level 118e which is a countermeasure to be implemented at a fourth time of the escalation.

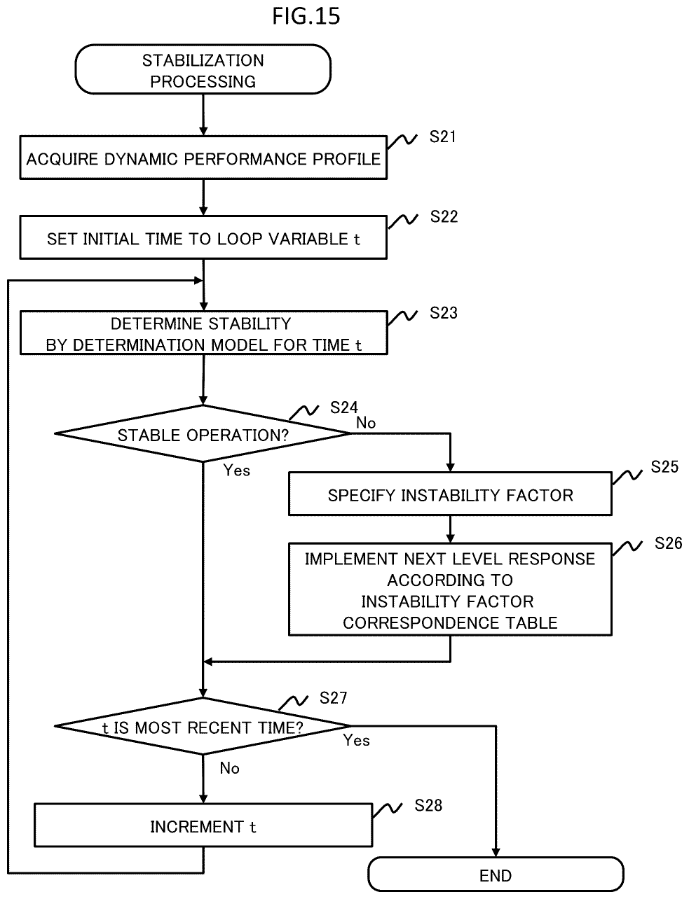

FIG. 15 is a diagram illustrating an example of a processing flow of stabilization processing. The stabilization processing is started, for example, when the UI device 130 receives an execution instruction of the stabilization processing from the user.

First, the load prediction unit 122 acquires the dynamic performance profile (step S21). Specifically, the load prediction unit 122 reads the dynamic performance profile data 117.

Then, the load prediction unit 122 sets the initial time to the loop variable t (step S22). Specifically, the load prediction unit 122 sets, as the loop variable t, the oldest time among the times 117a of the data recorded in the dynamic performance profile data 117.

Then, the stability determination unit 124 determines the stability by the determination model (step S23). Specifically, the stability determination unit 124 estimates whether the operation of the target device is in the stable state or the unstable state at the time T, by applying the design parameter data 112 and the data at the time T of the dynamic performance profile data 117 indicating the performance state to the determination model 114 which determines whether the target device is in the stable state or the unstable state.

Then, the stability determination unit 124 determines whether or not the determination result of the stability by the determination model is “stable” (step S24).

If the operation is not estimated to be in the stable state (“No” in step S24), the stabilization unit 126 specifies the instability factor (step S25). Specifically, in a case where the operation of the target device is estimated to be in the unstable state, the stabilization unit 126 specifies, as the instability factors, the load items or the reliability items in descending order of the contribution degree contributing to the improvement of the operation. Note that the stabilization unit 126 specifies a vector distance from the plotted position to the closest stable region on the determination model 114, and calculates, as the contribution degree, the distance of each of the item components of the design parameter or the performance profile.

Then, the stabilization unit 126 implements next level response according to the instability factor correspondence table 118 (step S26). Specifically, the stabilization unit 126 collates the instability factor specified in step S25 with the factor 118a in the instability factor correspondence table 118, and specifies and implements a countermeasure having a low escalation level among unimplemented countermeasures. Then, the stabilization unit 126 advances the control to step S27 described later.

If the operation is estimated to be in the stable state (“Yes” in step S24), the stability determination unit 124 determines whether the loop variable t is the most recent time (step S27). Specifically, the stability determination unit 124 determines whether the loop variable t is the most recent time 117a among the times 117a of the dynamic performance profile data 117. If the loop variable t is the most recent time (“Yes” in step S16), the stability determination unit 124 ends the stabilization processing.

If the loop variable t is not the most recent time (in a case of “No” in step S27), the stability determination unit 124 increments the loop variable t (for example, resets the loop variable t at the time that is the second oldest time after the loop variable t among the times 117a of the dynamic performance profile data 117) and returns the control to step S23 (step S28).

The above is an example of the processing flow of the stabilization processing. According to the stabilization processing, a countermeasure (issuing an alert, reducing a speed, stopping conveyor, or the like) necessary for stabilization when the operation is unstable can be performed on the basis of the performance profile data during the operation of the target device under the predetermined design parameters. Therefore, in a case where the operation of the target device is becoming unstable due to deterioration over time or the like, it is possible to maintain the stable operation as needed. The above is an example of the influence control system 2 according to the third embodiment of the present invention.

In addition, in the first embodiment described above, the influence prediction device 100 issues a warning regarding the necessity of the performance test in a case where the stable operation cannot be obtained, but the invention is not limited thereto. For example, in a case where the stability of the operation is not improved even if the warning is issued, a predetermined countermeasure for stabilizing the operation of the target device may be performed. In particular, regarding the AI processing, the processing load tends to be high and it is difficult to predict the processing amount, so that it is effective to change the design parameter related to the instability factor as the countermeasure for stabilizing the operation. In this way, it is possible to automatically prevent an accident of the target device. Such a modification will be described below as a fourth embodiment.

### Fourth Embodiment

An influence control system 2′ according to the fourth embodiment is basically similar to the influence prediction system 1 according to the first embodiment. Therefore, differences will be mainly described below.

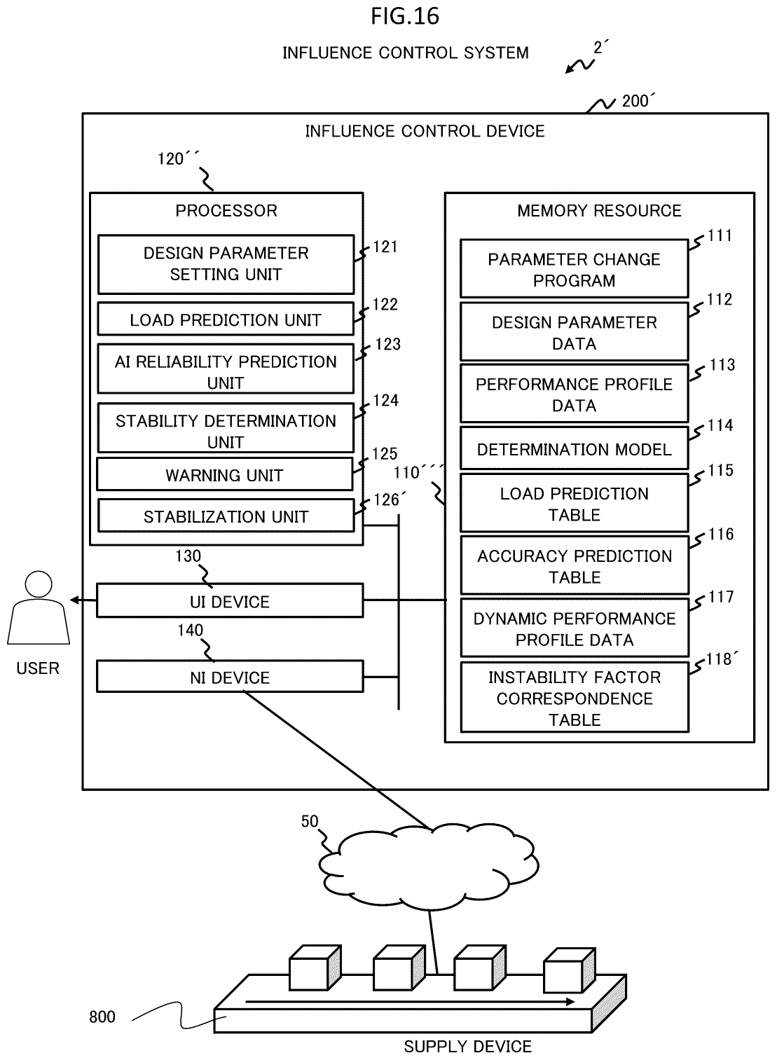

FIG. 16 is a diagram illustrating a configuration example of the influence control system. In the influence control system 2′, an influence control device 200′ automatically resets the control parameters, including that for AI control, of the target device (for example, the supply device 800 such as the conveyor) to be controlled, on the basis of the performance profile data during the operation of the target device. For example, the influence control device 200′ performs fps limitation for reducing an AI processing load or the like in addition to issuing an alert, reducing the speed of the conveyor, stopping, or the like, by resetting the control parameters.

The influence control device 200′ stores an instability factor correspondence table 118′ in a memory resource 110′″ together with the dynamic performance profile data 117. In addition, a processor 120″ includes a stabilization unit 126′. The stabilization unit 126′ specifies a countermeasure corresponding to the instability factor by using the instability factor correspondence table 118′ and performs the countermeasure.

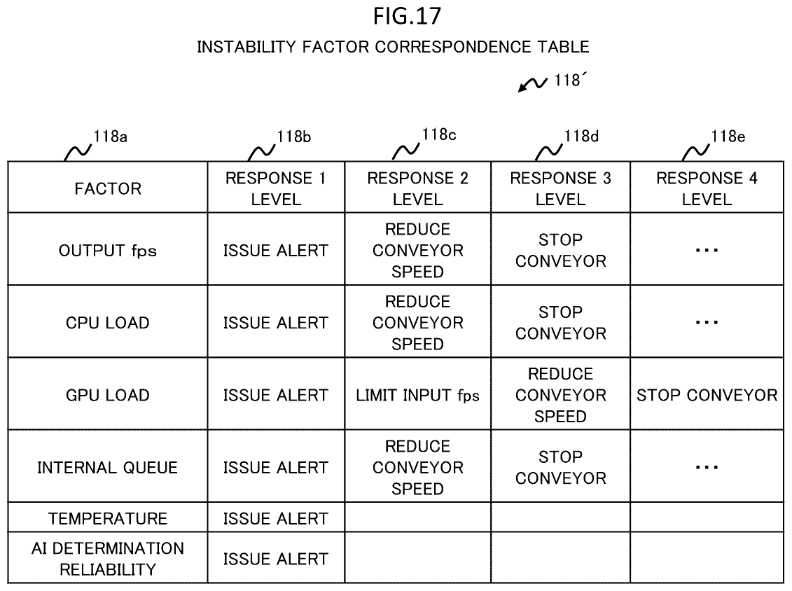

FIG. 17 is a diagram illustrating an example of the data structure of the instability factor correspondence table. In the instability factor correspondence table 118′, a countermeasure for stabilizing the operation of the target device is associated according to a factor that causes the operation of the target device to be unstable. In particular, the instability factor correspondence table 118′ includes the fps limitation for reducing the AI processing load. In addition, escalation can be set in order to take countermeasures in stages according to the installation environment of the target device, and a setting can be made such that, in a case where a plurality of factors have caused the operational instability, a more effective countermeasure is implemented.

Specifically, the instability factor correspondence table 118′ includes, for each factor 118a, the response 1 level 118b which is the countermeasure to be implemented at the first time of the escalation, the response 2 level 118c which is the countermeasure to be implemented at the second time of the escalation, the response 3 level 118d which is the countermeasure to be implemented at the third time of the escalation, and the response 4 level 118e which is the countermeasure to be implemented at the fourth time of the escalation.

For example, the instability factor correspondence table 118′ stores that, an alert is first issued in a case where the GPU load is the instability factor, the escalation is performed to limit the input fps of the camera in a case where the instability factor remains unresolved, the escalation is performed to reduce the conveyor speed in a case where the instability factor still remains unresolved, and the escalation is performed to stop the conveyor in a case where the instability factor still remains unresolved.

The stabilization unit 126′ of the influence control device 200′ performs the stabilization processing similar to that of the influence control system 2 according to the third embodiment, and in a case where the GPU load is the instability factor, performs fps limitation for reducing the AI processing load in processing step S26. The determination processing of the AI such as the deep learning or the like increases the GPU processing load, and in a case where the processing load exceeds a threshold, the GPU processing load may become a factor that causes an unstable state of the target device, such as a speed decrease of other processing or a failure in task switching. As a countermeasure, it is considered effective to temporarily reduce the processing load of deep learning.

According to the stabilization processing, a countermeasure necessary for stabilizing the AI processing when the operation is unstable can be performed on the basis of the performance profile data during the operation of the target device under the predetermined design parameters. Therefore, in a case where the operation of the target device is becoming unstable due to deterioration over time or the like, such as contamination of the lens of the camera or a decrease in illuminance of illumination for illuminating an inspection target, it is possible to maintain the stable operation as needed. The above is an example of the influence control system 2′ according to the fourth embodiment of the present invention. Note that, in a case where the UI device 130 of the influence control device 200′ performs fps limitation for reducing the AI processing load, a message indicating the limitation may be displayed. The above is an example of the influence control system 2 according to the fourth embodiment of the present invention.

In addition, in the first embodiment described above, the influence prediction device 100 predicts the load from the design parameter data by using the load prediction table 115 and predicts the accuracy of the estimation result of the AI from the design parameter data by using the accuracy prediction table 116, but the invention is not limited thereto. For example, instead of the load prediction table 115, a load prediction model having a plurality of pieces of design parameter data as explanatory variables and the load item as an objective variable may be used to estimate the load from the design parameters. In addition, instead of the accuracy prediction table 116, a reliability prediction model having a plurality of pieces of design parameter data as explanatory variables and the AI determination reliability as an objective variable may be used to estimate the accuracy from the design parameters. In this way, it is possible to more accurately estimate the load and the accuracy. Such a modification will be described below as a fifth embodiment.

### Fifth Embodiment

An influence prediction system 3 according to the fifth embodiment is basically similar to the influence prediction system 1 according to the first embodiment. Therefore, differences will be mainly described below.

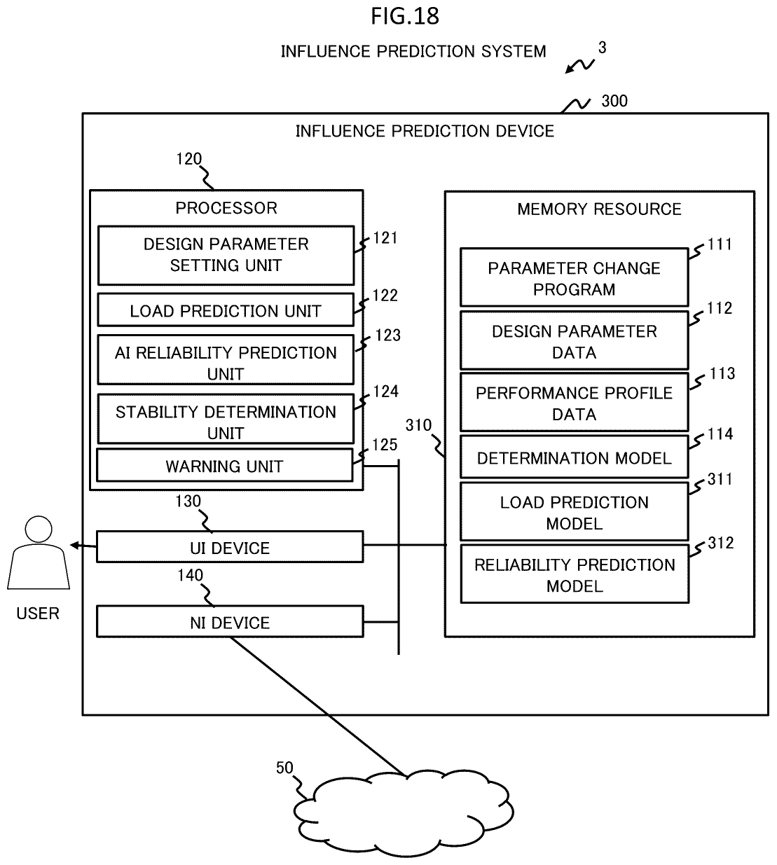

FIG. 18 is a diagram illustrating a third configuration example of the influence prediction system. In the influence prediction system 3, an influence prediction device 300 includes, in a memory resource 310, a load prediction model 311 having a plurality of pieces of design parameter data as explanatory variables and the load item as an objective variable, and a reliability prediction model 312 having a plurality of pieces of design parameter data as explanatory variables and the AI determination reliability as an objective variable.

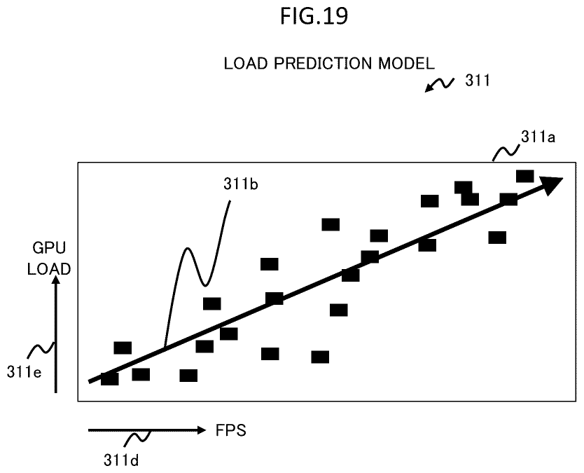

FIG. 19 is a diagram illustrating an example of a data structure of the load prediction model. In FIG. 19, for convenience of description, the FPS of the camera is targeted as the design parameter of the load prediction model 311, and the GPU load is targeted as the performance profile. However, the present invention is not limited thereto, and the load prediction model 311 may be multidimensional data including a plurality of other items. The load prediction model 311 includes an experimental result 311a of a GPU load 311e of the performance profile with respect to an increase in the FPS 311d of the design parameter and a regression line 311b obtained by multivariate analysis processing such as ridge regression. That is, the regression line 311b can be said to be a prediction model having the FPS as an explanatory variable and the GPU load as an objective variable. Note that the reliability prediction model 312 also has a similar data structure.

In step S02 of the performance test necessity determination processing, the load prediction unit 122 predicts the load, but the load prediction unit 122 according to the present embodiment estimates one or more load items (load items in the performance profile) to be a part of the performance state of the target device, by using the load prediction model 311 for the design parameter of the target device with a changed design instead of the load prediction table 115. More specifically, the load prediction unit 122 estimates each value of the load item by performing calculation by applying the value of the design parameter to the load prediction model 311.

Then, in step S03 of the performance test necessity determination processing, the AI reliability prediction unit 123 performs the AI reliability prediction, but the AI reliability prediction unit 123 according to the present embodiment estimates one or more reliability items (reliability items in the performance profile) to be a part of the performance state, by using the reliability prediction model 312 for the design parameter instead of the accuracy prediction table 116. Specifically, the AI reliability prediction unit 123 estimates each value of the reliability item by performing calculation by applying the value of the design parameter to the reliability prediction model 312. Note that, in general, it is obvious from experience that the load is generally proportional to the computation amount, but it tends to be difficult to specify the explanatory variable regarding the AI determination reliability, and thus, it is possible to perform estimation with higher accuracy by using the reliability prediction model 312. The above is an example of the influence prediction system 3 according to the fifth embodiment of the present invention.

Some or all of the above-described units, configurations, functions, processing units, and the like may be realized by hardware, for example, by designing with an integrated circuit. Further, each of the above-described units, configurations, functions, and the like may be realized by software by a processor interpreting and executing a program for realizing each function. Information such as a program, a table, and a file for realizing each function can be stored in a recording device such as a memory and a hard disk, or a recording medium such as an IC card, an SD card, and a DVD.

Note that control lines and information lines according to the above-described embodiments are those considered necessary for the purpose of description, and do not necessarily correspond to all of the control lines or information lines that are required in a product. In practice, almost all the configurations may be considered to be connected to each other. Hereinabove, the present invention has been described focusing on the embodiments.

What is claimed is:

1. A computer system including one or more processors and one or more memory resources, wherein
the one or more processors each include
a load prediction unit which estimates one or more load items to be a part of a performance state of a target device with a changed design, by using a predetermined load prediction table for a design parameter of the target device,
an accuracy prediction unit which estimates one or more reliability items to be a part of the performance state, by using a predetermined accuracy prediction table for the design parameter,
a stability determination unit which estimates whether an operation of the target device is in a stable state or an unstable state, by using the design parameter and a determination model which determines whether the target device is in a stable state or an unstable state by using a performance profile indicating the performance state as an input, and
a warning unit which displays, as instability factors, the load items or the reliability items in descending order of a contribution degree contributing to improvement of the operation in a case where the operation is estimated to be in the unstable state.

2. The computer system according to claim 1, wherein
the load items include an item indicating a use state of a hardware resource of the target device, and
the reliability items include accuracy information representing, in a distributed manner, a certainty of an estimation result of AI used in the target device.

3. The computer system according to claim 1, wherein
the load prediction table includes a load prediction constant based on an actual value of the performance profile for the design parameter in past, and
the load prediction unit estimates the load item corresponding to the design parameter by using the load prediction constant.

4. The computer system according to claim 1, wherein
the accuracy prediction table includes an accuracy prediction constant based on an actual value of the performance profile for the design parameter in past, and
the accuracy prediction unit estimates the reliability item corresponding to the design parameter by using the accuracy prediction constant.

5. The computer system according to claim 1, wherein
the determination model is a model obtained by multivariate analysis, in which each pair of the design parameter and its corresponding performance profile is associated.

6. The computer system according to claim 1, wherein
the processor
acquires, as the performance profile, a dynamic performance profile that is a time-series performance profile while the target device is in operation, and
estimates whether the operation of the target device is in the stable state or the unstable state by using the determination model for the acquired dynamic performance profile.

7. The computer system according to claim 1, wherein
the memory resource includes an instability factor correspondence table in which a countermeasure for stabilizing the operation of the target device is associated according to the estimated instability factor, and
the processor specifies a countermeasure corresponding to the instability factor by using the instability factor correspondence table, and performs the countermeasure.

8. The computer system according to claim 7, wherein
the countermeasure is to change a design parameter related to the instability factor.

9. The computer system according to claim 1, wherein
the memory resource includes a load prediction model that is a model obtained by multivariate analysis, in which each pair of the design parameter and its corresponding performance profile is associated, and
the load prediction unit estimates the load item corresponding to the design parameter by using the load prediction model instead of the load prediction table.

10. The computer system according to claim 1, wherein
the memory resource includes a reliability prediction model that is a model obtained by multivariate analysis, in which each pair of the design parameter and its corresponding performance profile is associated, and
the accuracy prediction unit estimates the reliability item corresponding to the design parameter by using the reliability prediction model instead of the accuracy prediction table.

11. A parameter changing method executed by a computer system including one or more processors and one or more memory resources, the parameter changing method causing the processors to perform:
a load prediction step of estimating one or more load items to be a part of a performance state of a target device with a changed design, by using a predetermined load prediction table for a design parameter of the target device;
an accuracy prediction step of estimating one or more reliability items to be a part of the performance state, by using a predetermined accuracy prediction table for the design parameter;
a stability determination step of estimating whether an operation of the target device is in a stable state or an unstable state, by using the design parameter and a determination model which determines whether the target device is in a stable state or an unstable state by using a performance profile indicating the performance state as an input; and
a warning step of displaying, as instability factors, the load items or the reliability items in descending order of a contribution degree contributing to improvement of the operation in a case where the operation is estimated to be in the unstable state.

12. The parameter changing method according to claim 11, wherein
the load items include an item indicating a use state of a hardware resource of the target device, and
the reliability items include accuracy information representing, in a distributed manner, a certainty of an estimation result of AI used in the target device.

13. The parameter changing method according to claim 11, wherein
the load prediction table includes a load prediction constant based on an actual value of the performance profile for the design parameter in past, and
in the load prediction step, the load item corresponding to the design parameter is estimated by using the load prediction constant.

14. The parameter changing method according to claim 11, wherein
the accuracy prediction table includes an accuracy prediction constant based on an actual value of the performance profile for the design parameter in past, and in the accuracy prediction step, the reliability item corresponding to the design parameter is estimated by using the accuracy prediction constant.
